(19) United States
(12) Patent Application Publication
(10) Pub. No.: US 2014/0237790 A1
(43) Pub. Date: Aug. 28, 2014

(54) PROTECTIVE APPARATUSES FOR ROTARY CONTROL KNOBS

(71) Applicant: Karim Messadek, Chanteloup Les Vignes (FR)

(72) Inventor: Karim Messadek, Chanteloup Les Vignes (FR)

(21) Appl. No.: 14/181,687

(22) Filed: Feb. 16, 2014

Related U.S. Application Data
(60) Provisional application No. 61/767,887, filed on Feb. 22, 2013.

(51) Int. Cl. G10H 1/32

(52) U.S. Cl. CPC G10H 1/32
USPC 29/401.1; 428/34.1

(57) ABSTRACT

It is one aspect of the present invention to provide novel protective apparatuses for rotary control knobs and the like configured to limit unintentional manipulation of a control actuator, such as a rotary knob, on an electronic device. In preferred embodiments, the apparatus comprises a cover member, coupling device, and a plate member configured to be secured to an electronic device. The cover member is configured to encase or surround a control actuator and to be engaged to the plate member by a coupling device. The coupling device may provide a temporary or permanent engagement between the cover member 11 and the plate member 12.

### CROSS REFERENCES TO RELATED APPLICATION

The present application claims priority to co-pending U.S. provisional patent application No. 61/767,887 filed Feb. 22, 2013, and entitled “SAFETY DEVICE FOR ROTARY CONTROL KNOBS” the entire contents of which are incorporated by reference herein.

### FIELD OF THE INVENTION

The present invention relates to the field of rotary knob protective and enhancing apparatuses. More specifically, the invention relates to apparatuses configured to limit rotational access to a knob.

### BACKGROUND

Foot operated effects pedals (sometimes referred to as “stomp boxes”) are frequently used by guitarists and other musicians to modulate or alter the sound of a musical instrument. They typically consist of an electronic circuit housed inside a relatively small enclosure, and a plurality of control knobs, foot-switches, toggle-switches, connectors, and the like.

The electronic circuit processes the incoming instrument signal before outputting it to an amplification system. Control knobs allow the user to adjust various key parameters of the electronic circuit. Foot-switches allow the musician to conveniently actuate the effect on and off using his foot.

The fast growing effects pedals market has provided musicians with hundreds, if not thousands of pedals of various types and sizes to choose from. New standards of pedal layout and quality have also been established by increasing numbers of boutique pedal manufacturers, making available to a greater number of musicians effects pedals that were only meant to be used by professionals in the past.

Musicians, especially guitarists, have learned to use and combine multiple effects pedals in order to create various sound effects which are typically described as various textures, colors, and shades of sounds. While being time consuming due to the almost endless pedal combinations and possibilities, finding the right combination is very rewarding and desirable for the tone-conscious musician.

The trend of using multiple effects pedals has, in turn, led manufacturers towards designing smaller, more compact pedals, so that a large number of them can be arranged onto reasonable sized pedal-boards. Pedal-boards are essentially platforms on which a plurality of effects pedals, audio interfaces, and power supplies are attached and arranged on.

The typical distance between the on/off foot-switch and the closest control knob, on today's effects pedals, can vary anywhere between 0.75 inches to 1.5 inches at most. Stepping on the on/off foot-switch without inadvertently disturbing or stepping on the control knobs can therefore be a challenging task. This challenge is even greater if the pedal sits in between other pedals on a tightly packed pedal-board. There is always a risk of accidentally disturbing the adjacent control knob's setting, and this scenario is simply not acceptable in the middle of a stage performance.

Control knobs settings can also be disturbed when musicians transport their effects pedals or pedal-boards inside light-weight soft bag (sometimes referred to as “gig bags”). The friction between the inner surfaces of the bag and the pedals often causes the control knobs to inadvertently move during transport, forcing the musicians to constantly reset the knobs positions before using the pedals.

Several related art arrangements are known to provide locking devices to securely hold a control knob setting. Devices shown in U.S. Pat. No. 4,154,125 and U.S. Pat. No. 4,347,758 work essentially by applying to the control knob or to the control shaft a sufficient drag force so to resist knob rotation from some external perturbations, like vibrations, or other small forces. However, an ‘on the fly’ operation of the control knob is impossible, since it requires the user to first unlock the locking device, set the knob position, and then re-lock the locking device. Performing musicians need to quickly change their knobs settings on one or more pedals in between songs during a set. They typically have a handful of seconds to tweak several knobs, which is impractical with these locking systems in place. Additionally, these locking devices do not provide any protection to the control knobs themselves and thus the knobs may fall off or otherwise become inadvertently damaged.

Unfortunately, many touring musicians tend to use duct tape and the like to secure their control knob settings. The tape is generally applied in a way that completely covers the control knob and part of the surrounding pedal surface, thus preventing the knob from moving. In this set-and-forget approach, neither a visual inspection, nor an ‘on the fly’ adjustment of the knob setting is possible.

The Company Hardwire™ has developed a proprietary device known as Stomplock™. It is essentially a molded rubber cover that achieves the same function as the duct tape method but in a more elaborate way. However, Stomplock™ cannot be applied to individual knobs and is suffers from the same set-and-forget solution drawbacks mentioned above.

Therefore, a need exists for novel protective apparatuses for rotary control knobs which effectively precludes any inadvertent or accidental disturbance of control knobs settings when actuating or transporting effects pedals. There is a further need for an apparatus that enables the user to quickly adjust, on the fly, the control knob settings with the protective apparatus in place. There also exists a need for an apparatus that provides the ability to perform, without physically interacting with the apparatus, visual monitoring and inspection of the knob settings. Finally, there exists a need for an apparatus which allows the ability to provide an easy retrofit protective solution to the knobs of any effects pedal without modification to the pedal or its components.

### BRIEF SUMMARY OF THE INVENTION

It is one aspect of the present invention to provide novel protective apparatuses for rotary control knobs and the like configured to limit unintentional manipulation of a control actuator, such as a rotary knob, on an electronic device. In preferred embodiments, the apparatus comprises a cover member, coupling device, and a plate member configured to be secured to an electronic device. The cover member is configured to encase or surround a control actuator and to be engaged to the plate member by a coupling device. The coupling device may provide a temporary or permanent engagement between the cover member 11 and the plate member 12.

A general object of the present invention is to provide a protective function that prevents any inadvertent or accidental operation of the rotary knob while allowing the rotary knob to be deliberately operated by a user with the protective device in place.

Another object of the present invention is to provide a protective function that prevents the rotary knob and thus the control device (potentiometer for instance) to be damaged while effects pedals are actuated and transported.

Another object of the present invention is to provide a direct and easy access to the rotary knob.

Another object of the present invention is to allow the user to visibly see the rotary knob and its current position or setting at any time and with no further action.

A further object of the present invention is to provide a device of minimum size.

Another object of the invention is to provide a simple retrofit of existing equipment such as stomp boxes.

Yet another object of the invention is to provide an assembly which is simple to manufacture and use.

### BRIEF DESCRIPTION OF THE DRAWINGS

Some embodiments of the present invention are illustrated as an example and are not limited by the figures of the accompanying drawings, in which like references may indicate similar elements and in which:

FIG. 1 depicts a side perspective view of an example of a protective apparatus for rotary control knobs according to various embodiments described herein.

FIG. 2 illustrates a side perspective view of an example of a protective apparatus for rotary control knobs according to various embodiments described herein.

FIG. 3A shows a side profile view of an example of a protective apparatus for rotary control knobs according to various embodiments described herein.

FIG. 3B shows a side profile view of an example of a protective apparatus for rotary control knobs according to various embodiments described herein.

FIG. 4A depicts a top view of an example of a plate member according to various embodiments described herein.

FIG. 4B depicts a bottom view of an example of a plate member according to various embodiments described herein.

FIG. 5 illustrates an exploded perspective view of the arrangement of members of an example of a protective apparatus for rotary control knobs over a rotary control knob assembly according to various embodiments described herein.

FIG. 6 shows a cut away perspective view of an example of a protective apparatus for rotary control knobs configured to encase a control knob according to various embodiments described herein.

FIG. 7 depicts a side perspective view of an example of a protective apparatus for rotary control knobs encasing a knob of an electronic device according to various embodiments described herein.

FIG. 8 illustrates a side profile view of an example of a protective apparatus for rotary control knobs encasing a knob of an electronic device according to various embodiments described herein.

FIG. 9A shows a perspective view of an example of a protective apparatuses for rotary control knobs configured to encase a control knob assembly according to various embodiments described herein.

FIG. 9B shows a perspective view of an example of a protective apparatuses for rotary control knobs configured to encase a control knob assembly according to various embodiments described herein.

FIG. 9C shows a perspective view of an example of a protective apparatuses for rotary control knobs configured to encase a control knob assembly according to various embodiments described herein.

FIG. 9D shows a perspective view of an example of a protective apparatuses for rotary control knobs configured to encase a control knob assembly according to various embodiments described herein.

### DETAILED DESCRIPTION OF THE INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

New protective apparatuses for rotary control knobs are discussed herein. In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention, and is not intended to limit the invention to the specific embodiments illustrated by the figures or description below.

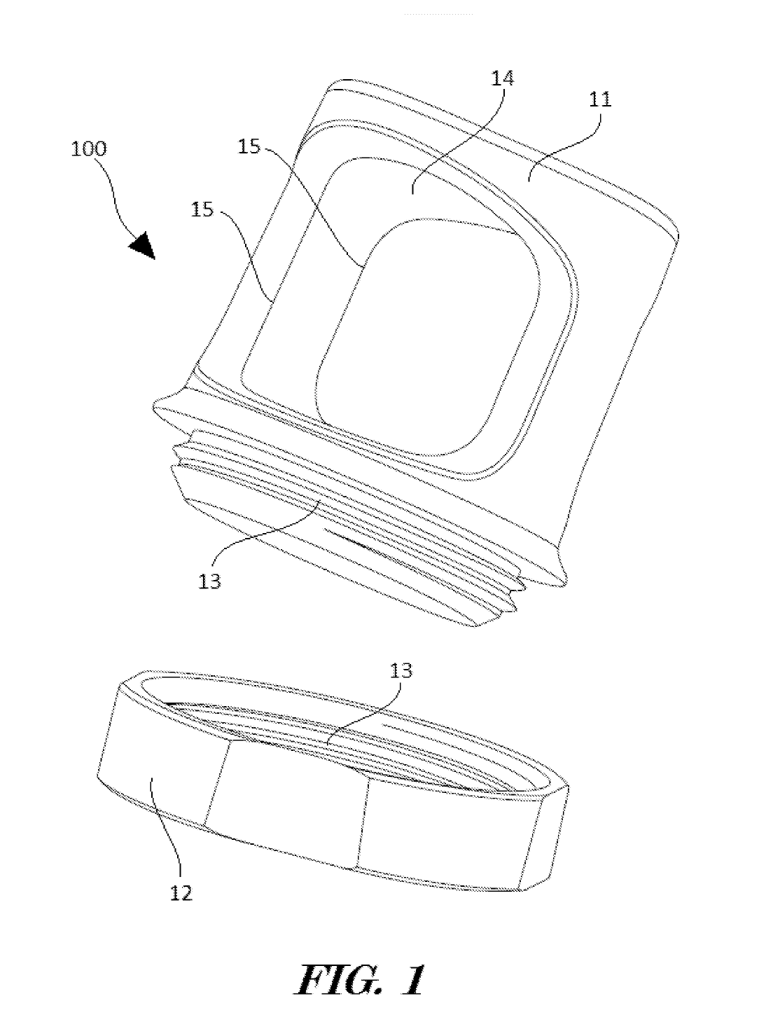

The present invention will now be described by example and through referencing the appended figures representing preferred and alternative embodiments. FIG. 1 illustrates an example of a protective apparatus for rotary control knobs (“the apparatus”) 100 according to various embodiments of the present invention. In this example, the apparatus 100 comprises a cover member 11, a plate member 12, and a coupling device 13 which is positioned on both the cover member 11 and the plate member 12.

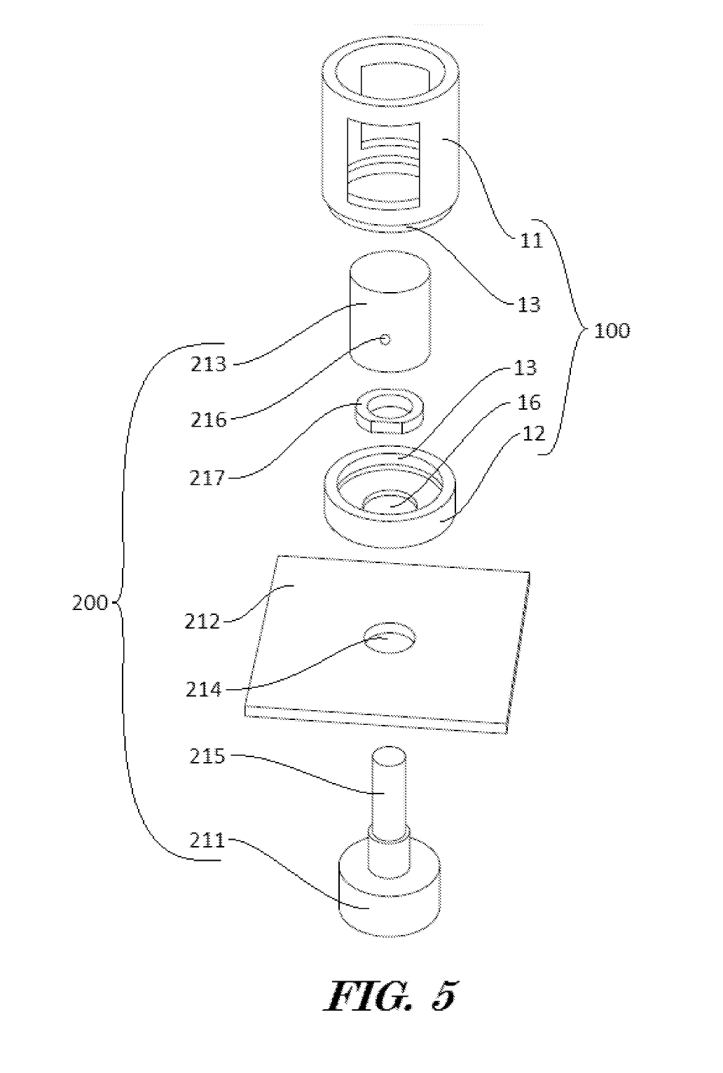

The cover member 11 is preferably fashioned in a cylindrical-like shape, comprising a knob cavity 14 configured to be larger than and to encase a desired rotary control knob, but other shapes can be envisioned. Also depicted in this embodiment are two access apertures 15 which are configured to allow access to the knob cavity 14 enabling a user to manipulate an encased control knob. The cover member 11 functions as a protective guard to limit unintentional manipulation of an encased control knob caused by accidentally bumping or impacting the knob. In some embodiments, setting marks can be machined on, or affixed to the cover member 11 to indicate to the user the degree of rotation of a knob 213 (FIG. 5).

A coupling mechanism 13 may be positioned along the lower circumference of the cover member 11 and is configured to engage and secure to a complementary coupling mechanism 13 positioned on the plate member 12. The function of the coupling device 13 is to create a removable connection where the cover member 11 and the plate member 12, may be completely separated at one time, and at another time be joined together so they act as a continuous part. In some embodiments, the coupling device 13 may be fashioned in the form of a threaded screw type connection method, a push-to-lock type connection method, a turn-to-lock type connection method, or any other suitable temporary connection method as one reasonably skilled in the art could envision to serve the same function.

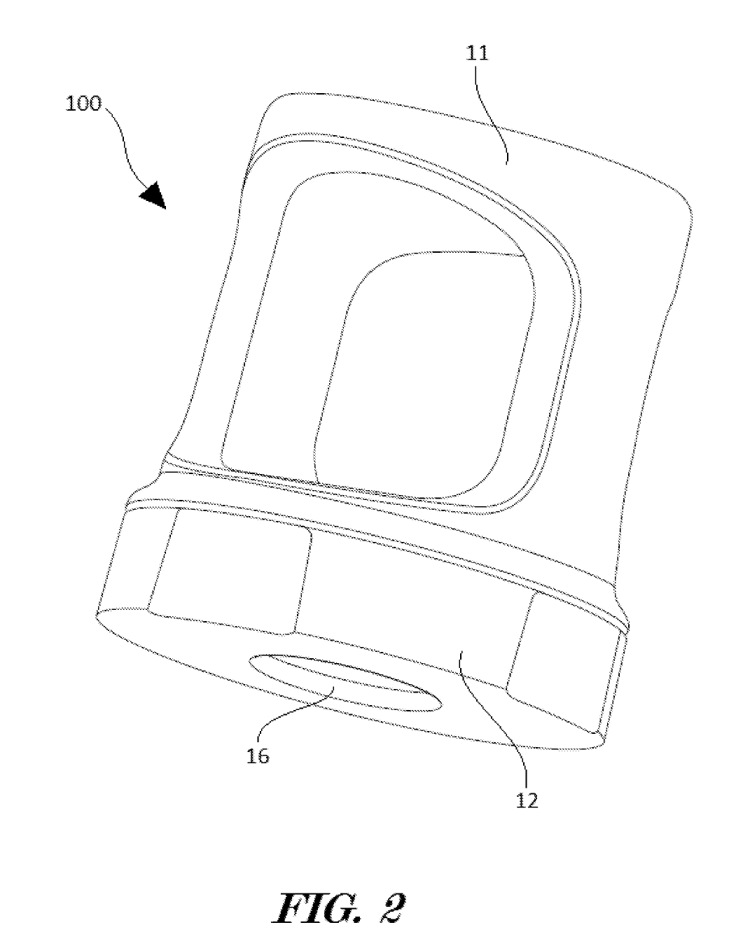

FIG. 2 illustrates a side perspective view of an example of an apparatus 100 according to various embodiments of the present invention. In this embodiment, the apparatus 100 comprises a cover member 11 that is securely engaged to a plate member 12 which comprises a control shaft aperture 16. In some alternative embodiments, the cover member 11 may be permanently engaged to the plate member 12 with glue, epoxy, chemical bonding, heat bonding, or other suitable permanent joining technique. In other alternative embodiments, the cover member 11 may be integrally formed to the plate member 12.

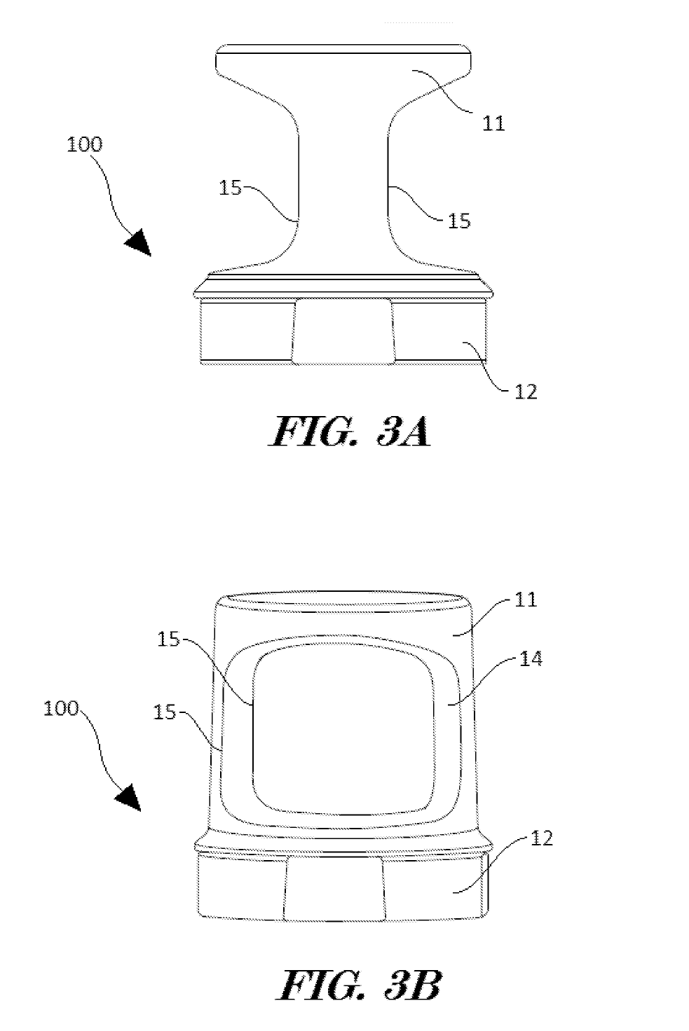

Turning now to FIG. 3, which shows two side perspective views of an example of an apparatus 100 according to various embodiments of the present invention. In FIG. 3A, the plate member 12 is engaged to the cover member 11 which comprises two oppositely positioned access apertures 15 which are configured to allow a user to access the knob cavity 14 (FIGS. 1 and 3B) with one or more fingers or any other suitable tool such as a guitar pick. As depicted in FIG. 3B, the apparatus 100 of FIG. 3A has been rotated approximately 90 degrees along a central axis so that the two access apertures 15 are viewed in-line with each other. Access apertures 15 may be substantially rectangular in shape, circular in shape, or comprise any other suitable geometric shape. In some embodiments, the apparatus 100 may contain one, two, three, four, five, or even six access apertures 15 providing access to the control knob 213 (FIG. 5).

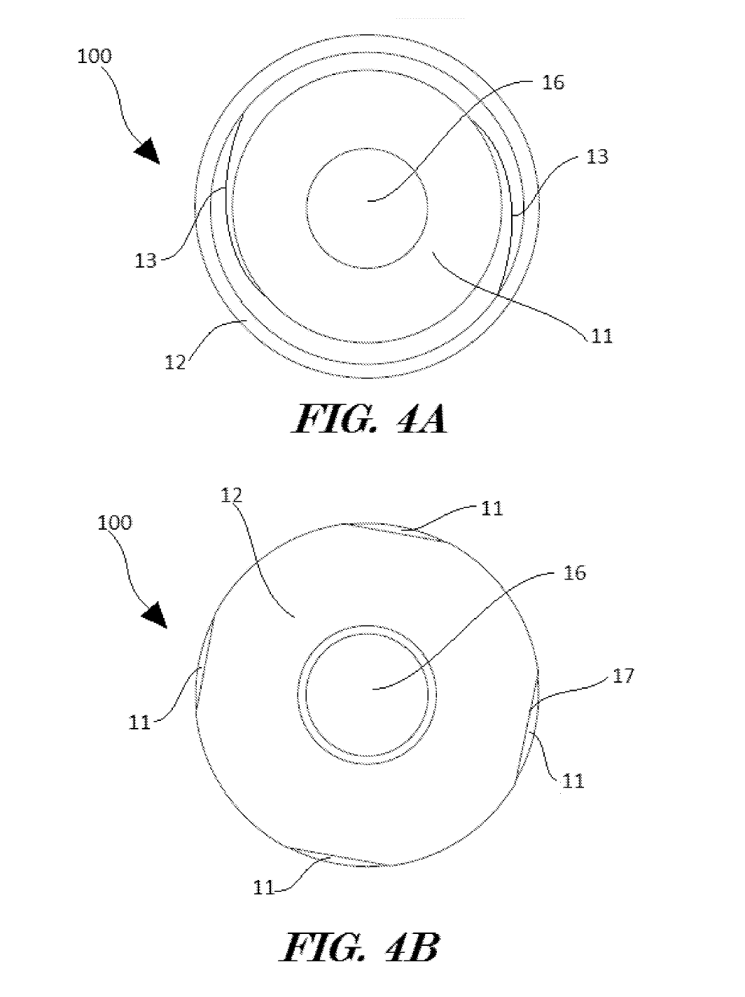

FIG. 4A depicts a top down view and FIG. 4B depicts a bottom up view of an example of an apparatus 100 with cover member 11 removable connected to plate member 12 with coupling device 13. As best shown in FIG. 4B, the plate member 12 comprises a control shaft aperture 16 configured to receive the control shaft 215 (FIG. 5) of a rotary control unit. The coupling device 13 is disposed on the upper surface of the plate member 12, while one or more facets 17 may be located on the perimeter edges of plate member 12. The one more facets 17 may be configured as indentions or grooves positioned around the perimeter of the plate member 12 and may be provided to facilitate improved gripping and handling, such as during installation and removal, of the plate member 12.

As perhaps best shown by FIG. 5, an exploded perspective view of the arrangement of members of an apparatus 100 over a rotary control knob assembly 200 according to various embodiments described herein is shown. In this example, the rotary control unit 211 is positioned below the case surface 212 of an electric device, such as an effects pedal or stomp box, and shown removed from the case aperture 214. Typically, the rotary control unit 211 is positioned adjacently below the case surface 212 so the control shaft 215 extends through the case aperture 214.

In preferred embodiments, to install the apparatus 100 depicted in FIG. 5, a set screw is removed from the set screw aperture 216 allowing the knob 213 to be removed from the control shaft 215. Next, the control shaft aperture 16 of the plate member 12 is placed over the control shaft 215 and placed in contact with the case surface 212 so that the control shaft aperture 16 and case aperture 214 are aligned allowing the control shaft 215 to be inserted through both case aperture 214 and control shaft aperture 16. A threaded fastener 217 which may preferably already be installed and included with a rotary control unit 211, may be used to secure the plate member 12 to the case surface 212. Although a threaded fastener 217 is shown by this example in FIG. 5, other types of fasteners may be used in some alternative embodiments. In this and in preferred embodiments, the user may adjust the plate member 12 (and optionally the cover member 11) in various orientations on case surface 212 to obtain the desired location for lateral access aperture(s) 15 before securing the plate member 12 with threaded fastener 217 or by other means. The ability to adjust the location of lateral access apertures 15 is valuable in circumstances where an electronic device may have multiple control knobs 213 and protective apparatuses 100 and allows optimal positioning of each aperture 15. Next, the knob 213 may then be replaced and secured on the control shaft 215 by attaching the set screw through the set screw aperture 216. Finally, the cover member 11 is attached to the plate member 12 by engagement of their respective coupling devices 13. Removal of the apparatus 100 may be accomplished by performing the above mentioned steps in a reverse order.

In preferred embodiments, the plate member 12 and cover member 11 may be adjustable, for example by rotation, allowing the optimal configuration of the access apertures 15 for a variety of different device setups and knob 213 configurations. In one example, the plate member 12 may be configured to rotate about a central vertical access on top of case surface 212 allowing for the desired orientation of the access apertures 15. In yet further examples, the cover member 11 may be configured to rotate about a center axis while connected to plate member 12, for example, by turning cover member 11 within a threaded coupling device 13, access apertures 15 may be positioned at optimal orientations.

In other embodiments, the plate member 12 and cover member 11 may be permanently engaged to each other so that the final step of attaching the cover member 11 to the plate member 12 of the above mentioned installation procedure may be omitted.

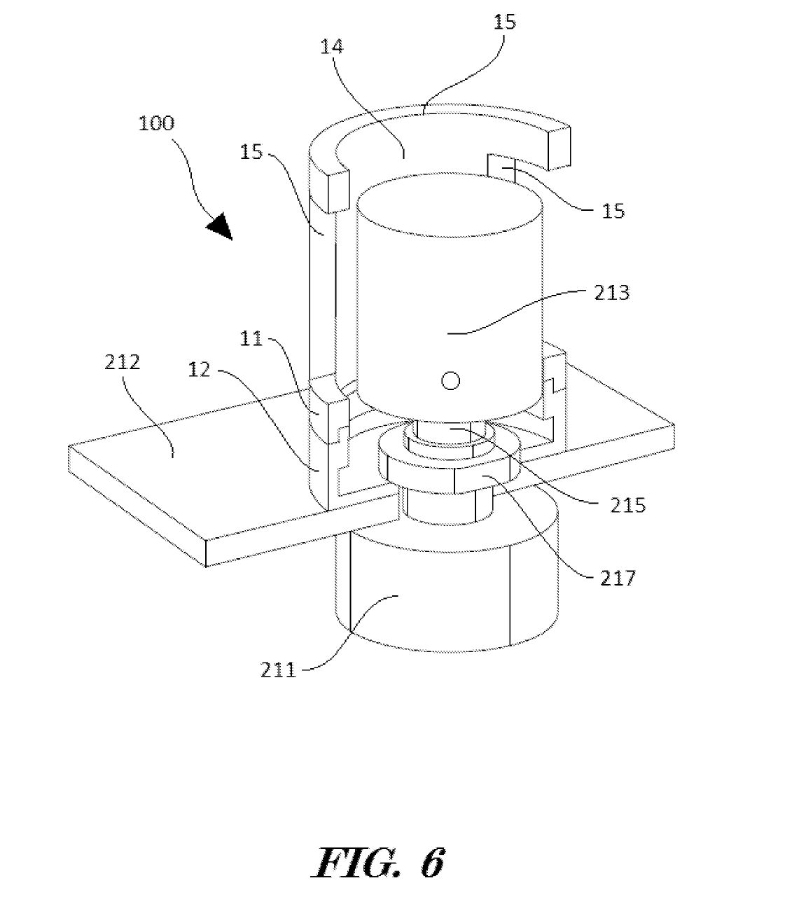

FIG. 6 shows a partial cut away perspective view of an example of an apparatus 100 configured to encase a control knob 213 according to various embodiments of the present invention. In this embodiment, the threaded fastener 217 is securing the plate member 12, and also the engaged cover member 11, to the case surface 212. The knob 213 is secured to the control shaft 215 of the rotary control unit 211 so that rotational motion of the knob 213 is transcribed into rotational movement of the rotary control unit 211. Two lateral access apertures 15 and a terminally positioned vertical access aperture 15 allow a user to manipulate the knob 213 located in the knob cavity 14 of the apparatus 100.

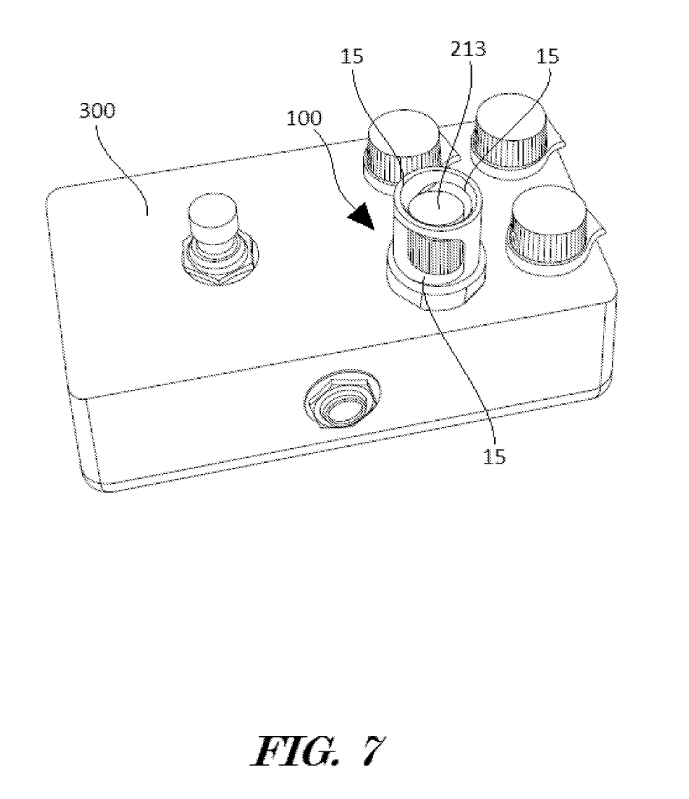

Turning now to FIG. 7, a side perspective view of an apparatus 100 encasing a knob 213 of an electronic device 300 according to various embodiments of the present invention is depicted. In this embodiment, one knob 213 of an electronic device 300, such as an effects pedal, is encased or surrounded by the apparatus 100 to prevent accidental and unintentional manipulation of the knob 213 so that the encased knob 213 may only be manipulated through two lateral access apertures 15 and a terminal vertical access aperture 15.

In this and preferred embodiments, the apparatus 100 is configured to surround or encase a knob 213 of an electronic device 300 such as an effects pedal. In other embodiments, the apparatus 100 may be configured to encase a rotary control unit, knob, button, switch, or other control actuator on any other electronic device 300. In further embodiments, the apparatus 100 may be configured to encase two or more control knobs or actuators simultaneously.

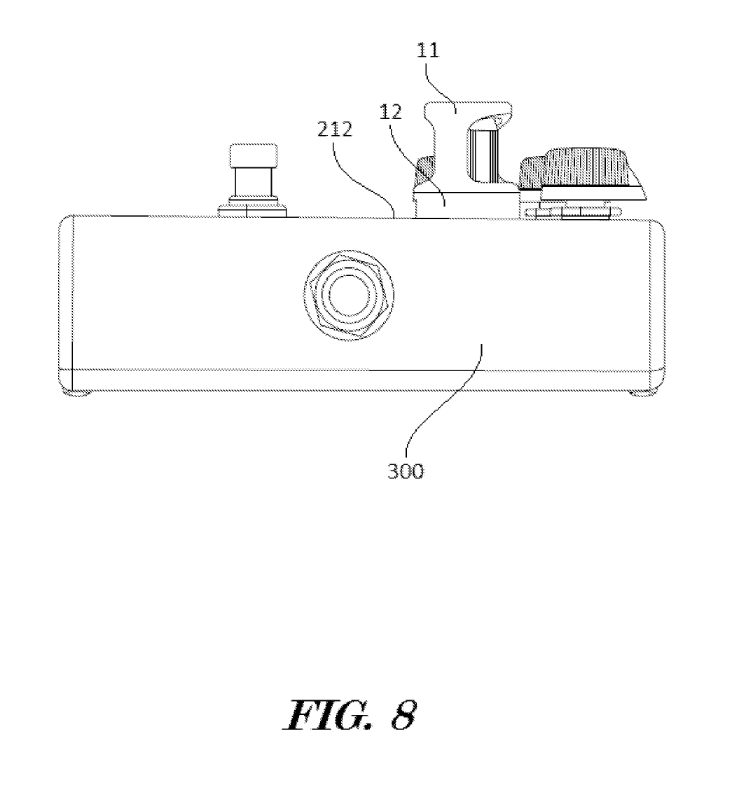

FIG. 8 illustrates a side profile view of an example of an apparatus 100 encasing a knob 213 of an electronic device 300 according to various embodiments of the present invention. The cover member 11 is surrounding a knob 213 and engaged to a plate member 12, while the plate member 12 is contacting the case surface 212 of the electronic device 300.

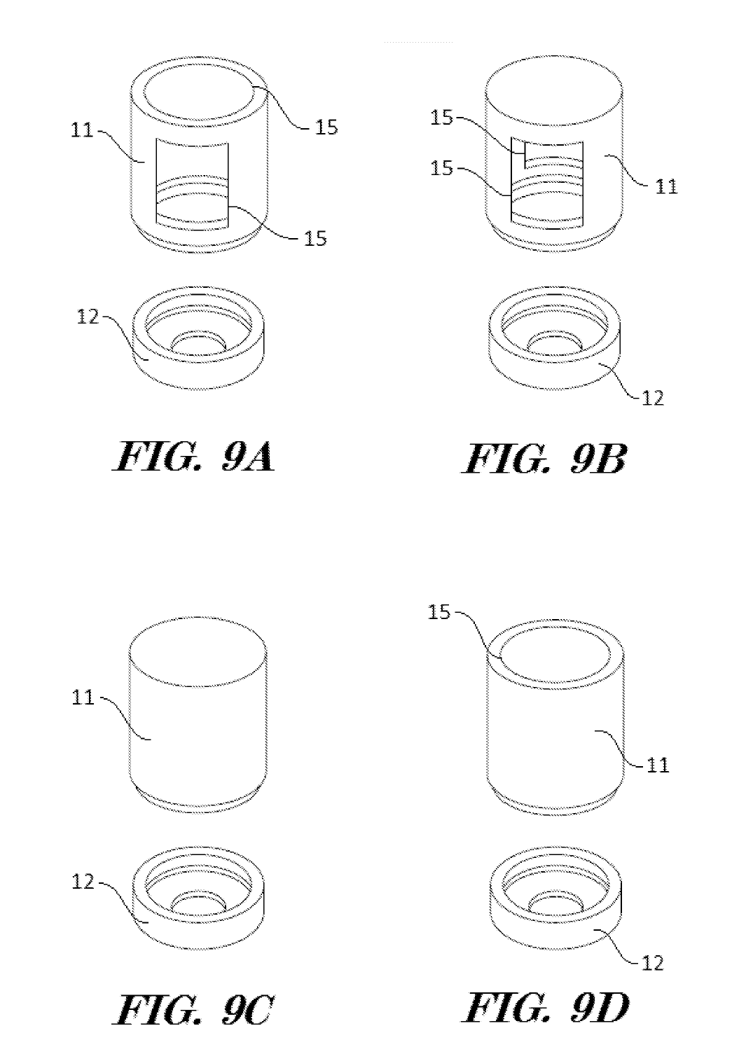

Various positions and configurations of the access apertures 15 on the cover member 11 are contemplated, with four exemplary embodiments shown in FIG. 9. The embodiment depicted in FIG. 9A depicts an apparatus 100 configured with one lateral and one terminal vertical access aperture 15. In other embodiments, the apparatus 100 may comprise two lateral access apertures 15 and no terminal vertical access apertures as shown in FIG. 9B wherein the top of the cover member 11 is substantially covered. In the embodiment depicted in FIG. 9C, the cover member 11 does not comprise any access apertures 15 so that the cover member 11 must be disengaged and removed from the plate member 12 in order to manipulate an encased knob 213 (FIGS. 5, 6, 7, and 8). In further embodiments, as illustrated in FIG. 9D, the cover member 11 of the apparatus 100 may comprise one terminally vertically positioned access aperture 15 and no lateral access apertures 15. In still further embodiments, one or more access apertures 15 may be positioned anywhere on the cover member 11 and/or the plate member 12. In even further embodiments, an apparatus 100 comprising fewer access apertures 15 may be considered to encase a knob 213 (FIGS. 5, 6, 7, and 8), while an apparatus 100 comprising a greater number of access apertures 15 may be considered to surround a knob 213 (FIGS. 5, 6, 7, and 8).

In preferred embodiments, the members and components that comprise the apparatus 100 may be made from durable materials such as hard plastics, metal alloys, wood, hard rubbers, carbon fiber, or any other suitable materials including combinations of materials. Additionally, one or more members may be made from durable and slightly flexible materials such as soft plastics, silicone, soft rubbers, or any other suitable materials including combinations of materials. In some embodiments, such as shown in FIG. 9C, the members may be made from transparent or semi-transparent materials to facilitate visual inspection of the encased knob settings.

Although the present invention has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present invention, are contemplated thereby, and are intended to be covered by the following claims.

What is claimed is:

1. A protective apparatus for rotary control knobs, the apparatus comprising:
a. a cover member adapted fit over a rotary control knob;
b. a knob cavity internal to the cover member adapted to provide space for the rotary control knob to rotate about; and
c. an access aperture located on the surface of cover member and adapted to provide limited user access to the rotary control knob.

2. The protective apparatus according to claim 1, further comprising two lateral access apertures located opposite one another on the side of the cover member.

3. The protective apparatus according to claim 2, further comprising one vertical access aperture located on the top of the cover member.

4. The protective apparatus according to claim 1, further comprising a coupling device located at the bottom of cover member.

5. The protective apparatus according to claim 4, further comprising a plate member.

6. The protective apparatus according to claim 5, wherein the plate member comprises a coupling device adapted to removable couple the cover member and plate member.

7. The protective apparatus according to claim 6, wherein the plate member contains a control shaft aperture adapted to receive the control shaft of a rotary control assembly.

8. The protective apparatus according to claim 7, further comprising two lateral access apertures located opposite one another on the side of the cover member.

9. The protective apparatus according to claim 8, further comprising one vertical access aperture located on the top of the cover member.

10. The protective apparatus according to claim 9, wherein the plate member is adapted to be secured against a case surface of an electronic device.

11. The protective apparatus according to claim 10, wherein the electronic device is a musical effects pedal.

12. The protective apparatus according to claim 11, wherein the electronic device is a stomp box.

13. The protective apparatus according to claim 12, wherein the plate member is configured to rotate about a central axis to change the orientation of the lateral access apertures.

14. The protective apparatus according to claim 12, wherein the cover member is configured to rotate about a central axis to change the orientation of the lateral access apertures.

15. A method for retrofitting a musical effects pedal with a protective apparatus to limit access to a control knob, the method comprising:
a. removing a set screw from a screw aperture located within a control knob;
b. removing the control knob from a control shaft;
c. placing a control shaft aperture of a plate member over the control shaft of a rotary control assembly;
d. placing the plate member in contact with an electronic device case surface so that the control shaft aperture is aligned with the control shaft and allowing the control shaft to be inserted through control shaft aperture;
e. securing plate member to electronic device case with a fastener;
f. securing the control knob on the control shaft by attaching a set screw through the set screw aperture;
g. removable securing a cover member to the plate member by engagement of a coupling devices located on both cover member and plate member.
